(19) United States
(12) Patent Application Publication
(10) Pub. No.: US 2002/0174109 A1
(43) Pub. Date: Nov. 21, 2002

(54) EVENT DETECTION WITH CONCURRENT DATA UPDATES

(76) Inventors: Kanianthra Mani Chandy, La Canada, CA (US); Eric T. Bax, Pasadena, CA (US)

Correspondence Address: MICHAEL A MANN, NEXSEN PRUET JACOBS & POLLARD LLC, PO DRWR 2426, COLUMBIA, SC, 29202-2426, US

(21) Appl. No.: 09/858,801

(22) Filed: May 16, 2001

(51) Int. Cl. G06F 7/00

(52) U.S. Cl. 707/3

(57) ABSTRACT

An event detection system allows data to be inserted while event conditions are being checked. Each record is assigned a time stamp as it is inserted into a database. Each event condition check is assigned a time stamp range. The event condition check then produces only those matches that have at least one record with a time stamp in the range and no record with a time stamp after the range. After each event condition check, the range is changed so that, in subsequent checks, no part of a previous range is duplicated and no time stamps are excluded from every checked range. As a result of this process, records may be inserted while event conditions are being checked.

### FIELD OF THE INVENTION

The present invention relates generally to computer processes, and, in particular, event detection by a programmed computer.

### BACKGROUND OF THE INVENTION

A computer-assisted event detection system receives data, checks the data to see if it To satisfies pre-selected “event conditions,” and then outputs the data that satisfies the event conditions.

For example, an event detection system may connect buyers and sellers in an electronic marketplace. The system could receive two types of data:

1. buyer records that each contain the following fields:

a. description of a desired item

b . a desired price at which to buy the item

c. contact information about the prospective buyer

2. seller records that each contain the following fields:

a. a description of an item for sale

b. a desired price at which to sell the item

c. contact information about the prospective seller

The records are preferably stored in a database in the memory of a programmed computer, with the buyer records in one table and the seller records in another table. An example of an event condition could be that a buyer record and a seller record describe the same item, perhaps further qualified by the condition that the buyer's price be at least as high as the seller price.

In general, the set of records that satisfies an event condition is called a “match.” In this example, a match is a set that includes a buyer record and a seller record. The match represents the “event” in which the condition was satisfied, namely, that a buyer and a seller have agreed on a price for an item, as indicated by the buyer's and seller's records. Thus, the purpose of an event detection system is to ascertain whether there are any events, that is, matches, that are not empty sets (sets with no records) but are sets that contain data records that satisfy the pre-selected condition.

Event detection systems have wide application in commerce, especially on the internet in so-called e-commerce, in government administration such as, for example, checking criminal records and fingerprints, and in transportation of goods and passengers.

In an event detection system, no match should be overlooked, but, rather, each match should eventually be found and output, but preferably only once. One way to ensure that a match is not output multiple times is to design the event detection system so that it (1) waits for a record, (2) checks for all possible matches that include the new record, (3) outputs any such matches, and then (4) resumes waiting for the next record.

However, this design approach has several disadvantages. First, records that arrive during event condition checks cannot be inserted into the database until the checks are complete. In other words, record insertion and event condition checks cannot take place “concurrently.”

Second, it is not possible to insert multiple records between event condition checks. Thus, it is not possible to delay event condition checks when there is heavy demand for record insertion to allow for insertion of all records received between condition checks.

Third, this design forces all event conditions to be checked with the same frequency.

By extending each record by one field per event condition, however, multiple records can be inserted between event condition checks and checked for event conditions at different frequencies. As each record is inserted, it can be marked as “unchecked” for each event condition. To conduct an event condition check, then, the system identifies all matches with at least one record marked “unchecked.” These matches are then output and all records previously marked “unchecked” during the event condition check can then be changed to “checked.”

This approach also has drawbacks. Records that arrive during event condition checks still cannot be inserted until the checks are complete. In other words, this design approach still does not permit concurrent record insertion. Also, adding new event conditions may be difficult because it would require adding a corresponding marker field to many existing records. Although this problem may be avoided by using a single marker field for all event conditions, the design of this event detection system still forces all event conditions to be checked with the same frequency.

In designs that permit the insertion of multiple records into databases between event checks, a method is needed to identify the matches with at least one “unchecked” record, i.e., matches that have not been previously output. An obvious and straight-forward approach is to produce all matches, then check each match, and output only the matches with at least one “unchecked” record. Unfortunately, this method becomes increasingly inefficient as the number of previously output matches increases. Another approach is to produce all matches that have “unchecked” records in each table in the database. This method inevitably produces duplicates of matches that have “unchecked” records in different tables. Extra computation is therefore required to identify these duplicates in order to avoid having multiple copies of the same matches as output. Thus, there remains a need for an event detection system in which (1) records can be inserted while event conditions are checked, (2) event conditions can be checked at different frequencies, (3) event conditions can be added and deleted without changing the structure of the database, and (4) event condition checks do not include producing previously output matches or producing duplicate matches.

### BRIEF SUMMARY OF THE INVENTION

According to its major aspects and briefly recited, the present invention is an event detection system that allows multiple data records to be inserted into a database and periodically checked to see if event conditions are satisfied while also allowing the checking of event conditions concurrently and at different frequencies. The present system allows event conditions to be added and deleted without changing the structure of the database. The system uses a method of event condition checking that produces each event condition match exactly once, without producing duplicate matches or discarding matches.

The invention operates as follows. Each data record is augmented with a “time stamp.”Each event condition check has a corresponding range of time stamps. (For each event condition, each successive check has a successive range of time stamps.) A record with a time stamp below the time stamp range is an “old record” with respect to the event condition check. Likewise, a record with a time stamp within the range is a “current record,” and a record with a time stamp above the range is a “new record.” Each event condition check produces only matches with at least one current record (to avoid reproducing matches from previous checks) and with no new records (to avoid producing matches that will be produced by later checks.)

Processing event checks while new records are being added concurrently can be done because every record inserted while an event condition is being checked will have a time stamp that identifies it as a “new record” and therefore not to be included in matches produced by the check of current records. Use of a time stamp avoids ambiguity about which records were checked and thus which matches should be produced by which event condition checks.

Processing multiple event condition checks concurrently is possible because each event condition check has its own range associated with it. The range defines which records are old, current and new.

The use of time stamps is thus a major feature of the present invention. However, other features and their advantages will be apparent to those skilled in the art of event detection from a careful reading of the Detailed Description of Preferred Embodiments, accompanied by the following drawings.

### BRIEF DESCRIPTION OF THE SEVERAL VIEWS OF THE DRAWING

In the figures,

FIG. 1 is a schematic diagram of an event detection system according to a preferred embodiment of the present invention; and

FIG. 2 is a schematic diagram of an alternative event detection system according to an alternative embodiment of the present invention.

### DETAILED DESCRIPTION OF PREFERRED EMBODIMENTS

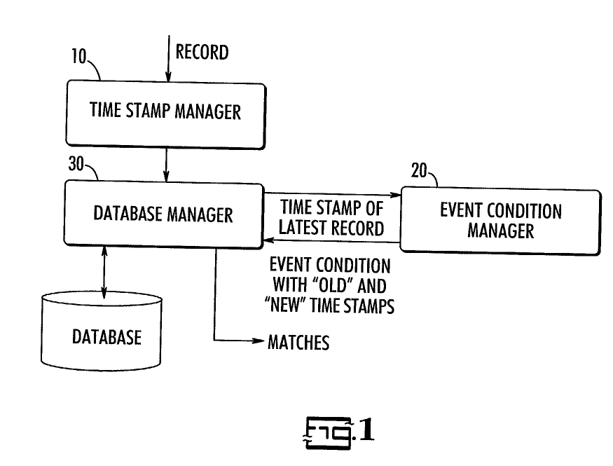

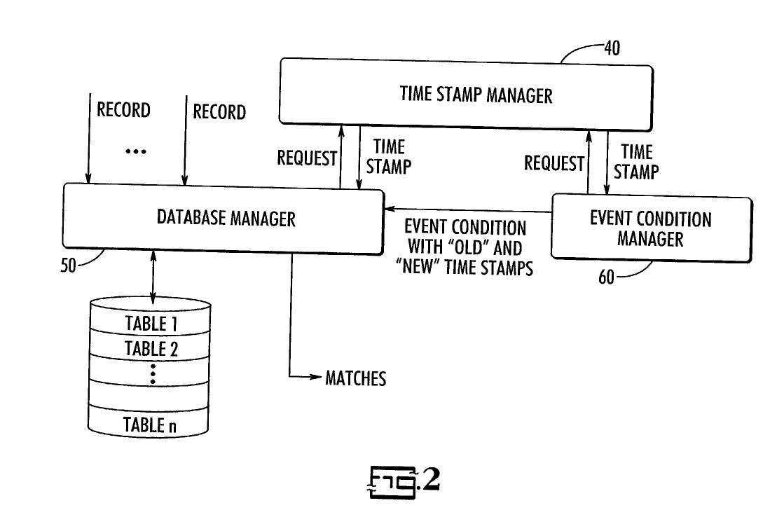

The descriptions below relate to the embodiments illustrated in FIGS. 1 and 2. The diagrams display subsystems and data flows. The system diagramed in FIG. 1 is a simpler embodiment than the alternative system diagramed in FIG. 2.

The term “record” refers to data that is structured; the data may be organized in one or more fields that are expected to contain specific types of information. Records will be intended for insertion into one or more tables of data in a database. If two or more records contain data that meet the pre-selected criteria, they will “match.” The existence of a found match is an “event.”

The following description is organized by subsystem. If a subsystem has multiple processes, the processes can run concurrently. On the other hand, some subsystems maintain variables that may be accessed by multiple processes. Multiple processes cannot access the same variable concurrently. If one process is executing a step that involves access to a variable, and a second process is set to begin executing a step that involves access to the same variable, then the second process yields until the step of the first process completes execution. (Likewise, third and further processes will also yield while waiting for the process with access to complete a step.) In the same manner, no more than one process at a time has access to any single beginning or end of a data flow. If a value arrives at the end of a data flow and no process is waiting to receive it, then the value is maintained until a process receives it. If other values arrive during the wait, the subsequent values form a queue. When a process receives a value, the value is removed from the queue.

Referring now to FIG. 1, a time stamp manager provides a time stamp for each record received. Note that a time stamp need not be related to actual time in any way, but merely to a sequence of values that increment (increase or decrease) with time. It is also not required that the values change as a function of time. Any values that can be compared to each other to determine which are higher (later in time) and lower (earlier in time) may be used as time stamps as long as the values increment so that no two records will receive the same time stamp. For the present example, it will be assumed that the time stamp value increases with passing time.

The time stamp manager has a single process, which is simply to repeat the following three steps:

1. Wait to receive a record.

2. Augment the record with a time stamp that is greater than any previous time stamp applied to a previous record.

3. Send the record as augmented with its time stamp to a database manager.

An event condition manager 20 has two processes. One of these two processes manages information about the time stamps correlated to the records inserted in the database. The other process manages the scheduling of event condition checks.

The first process, an information management process, maintains a time stamp variable named “latest.” Initially, the “latest” variable has a time stamp that is less than any time stamp issued by time stamp manager 10. This time stamp is called the “zero” time stamp. The information manager process repeats the following steps:

1. Wait to receive a time stamp from the database manager.

2. Replace the value of “latest” with the time stamp received from the database manager.

The other process, a scheduling management process, maintains a set of event conditions. For each event condition, the process maintains two time stamp variables: “old” and “new.”Initially, each “new” variable has the “zero” time stamp. For each event condition, the process repeats the following steps:

1. Replace the value of the “old” variable with the value of the “new” variable.

2. Replace the value of the “new” variable with the value of the “latest” variable.

3. Send the event condition and the corresponding “old” and “new” values to the database manager.

A database manager 30 has two processes. One process manages insertion of records into a database. The other process manages event condition checks on the database. The process that manages record insertion repeats the following steps:

1. Wait to receive a record, augmented with a time stamp, from the time stamp manager.

2. Insert the record, with the time stamp, into the database.

3. Forward the time stamp to the event condition manager.

The process that manages event condition checks repeats the following steps:

1. Wait to receive an event condition, with “old” and “new” time stamps, from the event condition manager.

2. Find all matches among records in the database for the event condition that have at least one record with a timestamp greater than “old” and have no records with time stamps greater than “new.”

3. Output each match found in the previous step.

Referring now to FIG. 2, the second, alternative embodiment of an event detection system according to a preferred embodiment of the present invention is more complex than the one illustrated in FIG. 1. This system offers the advantage of more opportunities for concurrently handling records and event conditions.

Records bound for different tables need not be inserted into the database in the order in which they are received. Furthermore, multiple records may be inserted simultaneously, and multiple event conditions may be checked simultaneously.

Time stamp manager 40 has a timestamp variable named “current” with an initial value set at a “zero” timestamp. Time stamp manager performs a process to supply time stamps to a database manager 50. There is another process to supply time stamps to an event condition manager 60.

The process that supplies time stamps to database manager 50 repeats the following steps:

1. Wait to receive a request from database manager 50.

2. Increase the value of the time stamp variable “current” and send the increased value to database manager 50.

The process that supplies time stamps to event condition manager 60 repeats the following steps:

1. Wait to receive a request from event condition manager 60 for a time stamp.

2. Increase the value of the timestamp variable “current” and send the increased value to event condition manager 60.

For each event condition, event condition manager 60 has a corresponding process. Each process maintains two time stamp variables, named “old” and “new.” Initially, each “new” variable has the “zero” time stamp value. Each process repeats the following steps:

1. Replace the value of the “old” variable with the value of the “new” variable.

2. Send a request to time stamp manager 40 for a time stamp.

3. Wait to receive a time stamp from time stamp manager 40.

4. Replace the value of the “new” variable with the time stamp received from time stamp manager 40.

5. Send an event condition and its corresponding “old” and “new” values to database manager 50.

Delays may be introduced between iterations of the sequence of steps in order to adjust the frequency of event condition checks. Varied delays for different processes may be used to vary the check frequencies among different event conditions.

For each table in the database, database manager 50 has a corresponding input data flow and two corresponding variables—a yes/no variable named “inserting” and a time stamp variable named “last.” Initially, each “inserting” variable has value “no,” and each “last” variable initially has the “zero” time stamp value. For each table, there is a corresponding process that inserts records into that table. In addition, there is a process that receives event conditions and launches processes to check event conditions.

Each process that inserts records into a table repeats the following steps:

1. Wait to receive a record from the input data flow corresponding to the table.

2. Set the value of the table variable “inserting” to “yes” when a record is received.

3. Send a request to time stamp manager 40 for a time stamp.

4. Wait to receive a time stamp from time stamp manager 40.

5. Insert the record into the table in the database, augmented with the received time stamp.

6. Replace the value of the table variable “last” with the value of the received time stamp.

7. Replace the value of the table variable “inserting” with “no.”

The process that receives event conditions repeats the following steps:

1. Wait to receive an event condition, with “old” and “new” time stamps, from the event condition manager.

2. Launch an event condition check process with the received event condition and “old” and “new” time stamps.

Each event condition check process includes the following steps:

1. Access the tables in the database related to the event condition to find all matches that have at least one record with a time stamp greater than “old” and have no records with time stamps greater than “new.” Before each access to a table, wait until the table variable “inserting” has value “no,” the table variable “last” has a time stamp greater than “new,” or both.

2. Output each match found in the previous step.

The method described may be used to find all matches for an event condition that have at least one record with a time stamp greater than “old” and have no records with time stamps greater than “new.” In the present specification, these matches will be referred to as “current matches.” Each record with a time stamp no greater than “old” will be referred to as an “old record.” Each record with a time stamp greater than “old” and no greater than “new” will be referred to as a “current record.” Finally, each record with a time stamp greater than “new” will be referred to as a “new record.” Current matches have at least one “current record” and no new records.

Current matches may be collected by the following method. First, the tables from which records are to be combined into matches define a “list of tables.” For each table in the list of tables, the system collects each match that has (1) a current record from the table, (2) an old record from each previous table in the list, and (3) an old or current record from each subsequent table in the list. The combined results are the “current matches.”

In the present specification, matches in which all records have time stamps no greater than “old” are referred to as “old matches.” Matches in which a record has a time stamp greater than “new” are referred to as “new matches.” The method is efficient in the sense that it does not produce old or new matches, only current matches, and it does not produce duplicates of current matches.

The following process is one way to implement the method. Let “n” be the number of tables from which records are to be combined in matches. Refer to the tables as Table 1, Table 2, . . . Table n. Initialize a variable “i” to value 1 and repeat the following steps “n” times:

1. Add to the set of matches those matches that have:

a. an old record from each table in the list: Table 1, . . . , Table i−1,

b. a current record from Table i, and

c. an old or current record from each table in the list: Table i+1, . . . , Table n.

2. Increase i by one.

If a list of tables as written in the method includes a Table 0 or a Table n+1, then the list is empty.

For example, to collect current matches for an event condition involving records from four tables:

1. Collect matches with a current record from Table 1 and an old or current record from each of Table 2, Table 3, and Table 4.

2. Add to the matches those matches that have an old record from Table 1, a current record from Table 2, and an old or current record from each of Table 3 and Table 4.

3. Add to the matches those matches that have an old record from each of Table 1 and Table 2, a current record from Table 3, and an old or current record from Table 4.

4. Add to the matches those matches that have an old record from each of Table 1, Table 2, and Table 3, and a current record from Table 4.

Those familiar with the art will realize that these system properties may be realized in a variety of implementations in addition to those described here. Note that time stamps, as used here, need not relate to time. Time stamps may be drawn from any set of objects or quantities for which subsets may be expressed. For example, time stamps may be numbers. Also, a time stamp range may consist of any subset of the set from which time stamps are drawn.

Other changes and substitutions will be apparent to those skilled in the art of event detection from the description of the foregoing preferred embodiments without departing from the spirit of the present invention, defined by the appended claims.

What is claimed is:

1. A method for detecting matching records among a flow of records into a database, said method comprising the steps of:
establishing a condition for use in selecting a set of matching records;
applying a time stamp to each record in a flow of records as said each record enters a database;
incrementing said time stamp after applying said time stamp to said each record so that said each record has a different time stamp;
defining a sequence of time stamps from a first time stamp to a latest time stamp;
defining a set of current records from records in said flow of records wherein each record in said set of current records has a time stamp falling between said first time stamp and said latest time stamp;
applying said condition to said database to find a set of matching records wherein said set of matching records includes at least one current record from said set of current records and no records having a time stamp greater than said latest time stamp; and
outputting said matching records.

2. The method as recited in claim 1, further comprising the step, following said condition applying step, of redefining said sequence of time stamps wherein said latest time stamp becomes said first time stamp and a later time stamp becomes said latest time stamp.

3. The method as recited in claim 1, wherein said time stamp applying step further comprises the steps of:
applying said time stamp to said record; and then
inserting said record into said database.

4. The method as recited in claim 1, wherein said time stamp applying step further comprises the steps of:
inserting said record into said database;
applying said time stamp to said record while blocking said condition applying step until said time stamp is applied to said record.

5. The method as recited in claim 1, wherein said database includes plural tables, said each record being inserted into one table of said plural tables, and wherein said matching records include at most one record from said one table and at most one record from another table of said plural tables.

6. A method for detecting matching records among a flow of records into a database, said method comprising the steps of:
establishing an event condition;
establishing a latest variable, an old variable and a new variable;
setting said new variable to a value of zero;
receiving a record from a flow of records;
augmenting said record with a time stamp;
replacing the value of said latest variable with said timestamp;
replacing the value of said old variable with the value of said new variable;
replacing the value of said new variable with the value of said latest variable;
inserting said augmented record into a database; and
finding all matches among records in said database for said event condition that have at least one record with a timestamp greater than said old time stamp and no records with time stamps greater than said new time stamp.

7. A system for detecting records that meet pre-selected conditions, said system comprising:
means for creating a flow of records;
a database for receiving each record in said flow of records;
time stamp manager means for issuing a time stamp to said each record entering said database and for incrementing said time stamp;
means for establishing a range of time stamps beginning with a first time stamp and ending with a latest time stamp;
means for storing a preselected condition;
condition manager means for applying a pre-selected condition to each record in said flow of records having a time stamp in said range of time stamps in order to find a current match between a record having a time stamp within said range and a record within said flow of records; and
means for outputting said current match.

8. The system as recited in claim 7, wherein said time stamp manager applies said time stamps to said each record before said each record enters said database.

9. The system as recited in claim 7, wherein said time stamp manager increments said time stamp after issuing said time stamp to said each record.

10. The system as recited in claim 7, wherein said database includes plural tables and wherein said system further comprises means for collecting current matches from said plural tables.
